(19) United States
(12) Patent Application Publication
(10) Pub. No.: US 2026/0018674 A1
(43) Pub. Date: Jan. 15, 2026

(54) SECONDARY BATTERY

(71) Applicant: MURATA MANUFACTURING CO., LTD., Kyoto (JP)

(72) Inventors: Kikou YAMAGUCHI, Kyoto (JP); Yasuyuki MASUDA, Kyoto (JP)

(21) Appl. No.: 19/336,919

(22) Filed: Sep. 23, 2025

Related U.S. Application Data
(63) Continuation of application No. PCT/JP2024/022688, filed on Jun. 21, 2024.

(30) Foreign Application Priority Data
Jun. 22, 2023 (JP) 2023-102637

(51) Int. Cl. H01M 10/0569; H01M 10/0525

(52) U.S. Cl. CPC H01M 10/0569; H01M 10/0525; H01M 2300/0028

(57) ABSTRACT

Provided is a secondary battery that makes it possible to achieve a superior battery characteristic. The secondary battery includes a positive electrode, a negative electrode, and an electrolytic solution. The negative electrode includes lithium metal. The electrolytic solution includes a solvent. The solvent includes an orthocarbonic acid ester compound represented by Formula (1). A content of the orthocarbonic acid ester compound in the solvent is greater than or equal to 40 wt %.

### CROSS REFERENCE TO RELATED APPLICATIONS

The present application is a continuation of International Application No. PCT/JP2024/022688, filed on Jun. 21, 2024, which claims priority to Japanese Patent Application No. 2023-102637, filed on Jun. 22, 2023, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

For example, a positive electrode active material includes manganese oxide, a negative electrode active material includes lithium metal, a solvent of an electrolytic solution includes a chain tetraether, and a content of the chain tetraether in the solvent is within a range from 1 vol % to 20 vol % both inclusive. In addition, a non-aqueous electrolytic solution includes an orthocarbonic acid ester, and a content of the orthocarbonic acid ester in the non-aqueous electrolytic solution is within a range from 0.001 mmol/g to 0.18 mmol/g both inclusive.

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a secondary battery that makes it possible to achieve a superior battery characteristic.

A secondary battery according to an embodiment of the present technology includes a positive electrode, a negative electrode, and an electrolytic solution. The negative electrode includes lithium metal. The electrolytic solution includes a solvent. The solvent includes an orthocarbonic acid ester compound represented by Formula (1). A content of the orthocarbonic acid ester compound in the solvent is greater than or equal to 40 wt %.

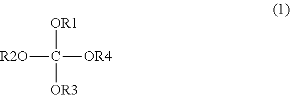

where:
each of R1, R2, R3, and R4 is a hydrocarbon group.

### Effects of the Invention

According to the secondary battery of an embodiment of the present technology, the negative electrode includes the lithium metal, the solvent of the electrolytic solution includes the orthocarbonic acid ester compound represented by Formula (1), and the content of the orthocarbonic acid ester compound in the solvent is greater than or equal to 40 wt %. This makes it possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating, in an enlarged manner, a configuration of a battery device illustrated in FIG. 1.

FIG. 3 is a block diagram illustrating a configuration of an application example of the secondary battery.

### DETAILED DESCRIPTION

The present technology is described below in further detail including with reference to the drawings according to an embodiment.

A description is given first of a secondary battery according to an embodiment of the present technology.

In the secondary battery to be described here, a battery capacity is obtained by utilizing precipitation and dissolution of lithium; accordingly, the secondary battery to be described here is what is called a lithium metal secondary battery.

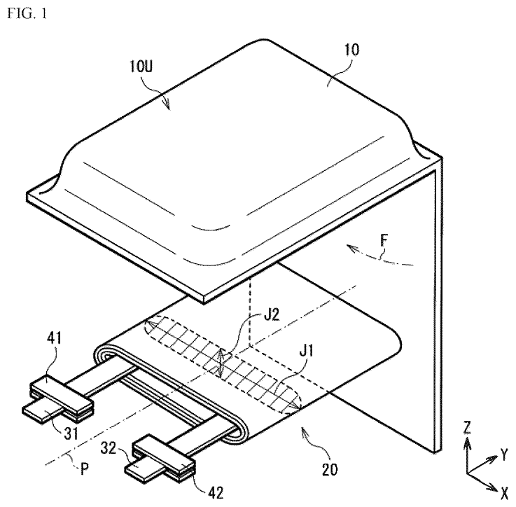

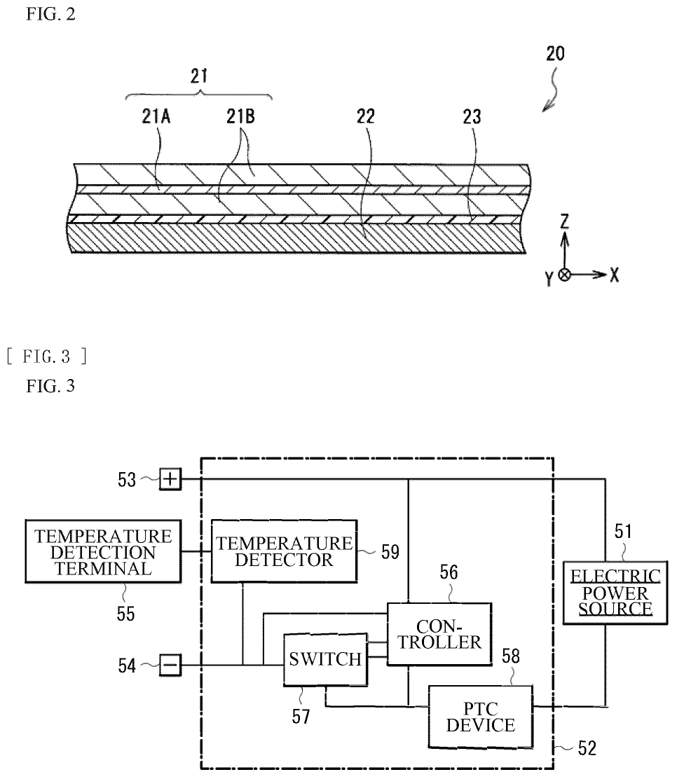

FIG. 1 illustrates a perspective configuration of the secondary battery. FIG. 2 illustrates, in an enlarged manner, a sectional configuration of a battery device 20 illustrated in FIG. 1.

Note that FIG. 1 illustrates a state where an outer package film 10 and the battery device 20 are separated from each other. FIG. 1 illustrates a section of the battery device 20 along an XZ plane by a dashed line. FIG. 2 illustrates only a part of the battery device 20.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 that is flexible or soft as an outer package member that is to contain the battery device 20 as described above. The secondary battery illustrated in FIGS. 1 and 2 is thus a secondary battery of what is called a laminated-film type.

As illustrated in FIG. 1, the outer package film 10 has a pouch-shaped structure that is sealed in a state where the battery device 20 is contained in the outer package film 10. The outer package film 10 thus contains a positive electrode 21, a negative electrode 22, and a separator 23 that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in the number of layers, and may be single-layered or two-layered, or may include four or more layers.

The battery device 20 is contained in the outer package film 10. The battery device 20 is what is called a power generation device, and includes, as illustrated in FIGS. 1 and 2, the positive electrode 21, the negative electrode 22, the separator 23, and an electrolytic solution (not illustrated).

Here, the battery device 20 is what is called a wound electrode body. The positive electrode 21 and the negative electrode 22 are thus wound about a winding axis P, being opposed to each other with the separator 23 interposed therebetween. As illustrated in FIG. 1, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B. Note, however, that the positive electrode current collector 21A may be omitted.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials into which lithium is to be inserted and from which lithium is to be extracted. Note that the positive electrode active material layer 21B may further include any one or more of other materials. Examples of the other materials include a positive electrode binder and a positive electrode conductor. A method of forming the positive electrode active material layer 21B is not particularly limited, and specifically includes a method such as a coating method.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The negative electrode 22 is opposed to the positive electrode 21 with the separator 23 interposed therebetween as illustrated in FIG. 2, and includes lithium metal.

The lithium metal is what is called a simple substance of lithium. Note that purity of the lithium metal is not necessarily limited to 100%. The lithium metal may therefore unintentionally include any amount of impurity, or may intentionally include any amount of additive matter.

The separator 23 is an insulating porous film interposed between the positive electrode 21 and the negative electrode 22 as illustrated in FIG. 2. The separator 23 allows lithium to pass therethrough in an ionic state while preventing a short circuit caused by contact between the positive electrode 21 and the negative electrode 22. The separator 23 includes any one or more of insulating polymer compounds. Specific examples of the insulating polymer compound include polyethylene.

The electrolytic solution is a liquid electrolyte. The positive electrode 21 and the separator 23 are each impregnated with the electrolytic solution. The electrolytic solution includes a solvent and an electrolyte salt, and the solvent includes an orthocarbonic acid ester compound. A detailed configuration of the electrolytic solution will be described later.

As illustrated in FIGS. 1 and 2, the positive electrode lead 31 is a positive electrode wiring coupled to the positive electrode current collector 21A of the positive electrode 21, and is led to an outside of the outer package film 10. The positive electrode lead 31 includes any one or more of electrically conductive materials including, without limitation, a metal material. Specific examples of the electrically conductive material include aluminum. The positive electrode lead 31 has a shape such as a thin plate shape or a meshed shape.

As illustrated in FIGS. 1 and 2, the negative electrode lead 32 is a negative electrode wiring coupled to the negative electrode 22, and is led to the outside of the outer package film 10. Here, the negative electrode lead 32 is led toward a direction similar to that in which the positive electrode lead 31 is led out. The negative electrode lead 32 includes any one or more of electrically conductive materials including, without limitation, a metal material. Specific examples of the electrically conductive material include copper. Details of a shape of the negative electrode lead 32 are similar to those of the shape of the positive electrode lead 31.

The sealing film 41 is interposed between the outer package film 10 and the positive electrode lead 31 as illustrated in FIG. 1. The sealing film 42 is interposed between the outer package film 10 and the negative electrode lead 32 as illustrated in FIG. 1. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

Details of the configuration of the electrolytic solution are as described below.

The electrolytic solution includes the solvent as described above. The solvent is a medium that allows for dissolution and ionization of the electrolyte salt.

The solvent includes any one or more of orthocarbonic acid ester compounds represented by Formula (1). The electrolytic solution whose solvent includes the orthocarbonic acid ester compound, which is a non-aqueous solvent, is therefore what is called a non-aqueous electrolytic solution.

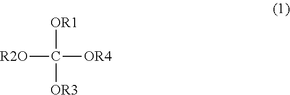

where:
each of R1, R2, R3, and R4 is a hydrocarbon group.

As is apparent from Formula (1), the orthocarbonic acid ester compound corresponds to a compound in which four oxygen-containing groups (—OR1, —OR2, —OR3, and —OR4) are coupled to a carbon atom. Each of R1 to R4 is a hydrocarbon group as described above. R1 to R4 may be of the same kind, or may be of respective kinds different from each other. Needless to say, only any two of R1 to R4 may be of the same kind, or only any three of R1 to R4 may be of the same kind.

The term “hydrocarbon group” is a generic term for a group including carbon and hydrogen as constituent elements. Carbon number of the hydrocarbon group is not particularly limited. The hydrocarbon group may be a chain group, a cyclic group, or a group in which a chain group and a cyclic group are coupled to each other. Note that the chain group may have a straight-chain structure, or may have a branched structure having one or more side chains.

Specific examples of the hydrocarbon group include an alkyl group, an alkenyl group, an alkynyl group, an aryl group, a cycloalkyl group, and a linking group. Details of the linking group will be described later.

Specific examples of the alkyl group include a methyl group, an ethyl group, a propyl group, and a butyl group. Specific examples of the alkenyl group include a vinyl group and an allyl group. Specific examples of the alkynyl group include an ethynyl group. Specific examples of the aryl group include a phenyl group and a naphthyl group. Specific examples of the cycloalkyl group include a cyclopropyl group, a cyclobutyl group, a cyclopentyl group, and a cyclohexyl group.

The “linking group” is a generic term for a monovalent group in which two or more of an alkyl group, an alkenyl group, an alkynyl group, an aryl group, and a cycloalkyl group are coupled to each other. Specific examples of the linking group include a benzyl group, which is a monovalent group in which an aryl group (a phenyl group) and an alkyl group (a methyl group) are coupled to each other.

In particular, it is preferable that the hydrocarbon group include an alkyl group and that carbon number of the alkyl group be less than or equal to 3. One reason for this is that this improves solubility and compatibility of the orthocarbonic acid ester compound and facilitates synthesis of the orthocarbonic acid ester compound.

Specific examples of the orthocarbonic acid ester compound include tetramethyl orthocarbonate (R1=R2=R3=R4=a methyl group), tetraethyl orthocarbonate (R1=R2=R3=R4=an ethyl group), tetrapropyl orthocarbonate (R1=R2=R3=R4=a propyl group), and tetraisopropyl orthocarbonate (R1=R2=R3=R4=an isopropyl group).

Note that a content of the orthocarbonic acid ester compound in the solvent is set to a predetermined amount. Specifically, the content of the orthocarbonic acid ester compound in the solvent is greater than or equal to 40 wt %.

One reason why the solvent includes the orthocarbonic acid ester compound and the content of the orthocarbonic acid ester compound in the solvent is greater than or equal to 40 wt % is that, even if the negative electrode 22 includes the lithium metal, a decomposition reaction of the electrolytic solution on a surface of the negative electrode 22 is suppressed upon charging and discharging.

More specifically, the orthocarbonic acid ester compound has a property of sufficiently allowing for dissolution and ionization of the electrolyte salt by itself and is therefore superior as the solvent to be used for the electrolytic solution. Thus, the electrolytic solution functions effectively even if only the orthocarbonic acid ester compound is used as the solvent.

Moreover, the orthocarbonic acid ester compound has a high lowest unoccupied molecular orbital (LUMO) level and therefore has superior reduction resistance. Accordingly, the orthocarbonic acid ester compound included in the solvent is prevented from being easily decomposed upon charging and discharging, which allows the electrolyte salt and another compound, which is to be described later, to be decomposed preferentially over the orthocarbonic acid ester compound. This makes it easier for a film derived from the electrolyte salt and the other solvent to be formed on the surface of the negative electrode 22, and the surface of the negative electrode 22 is thus electrochemically protected by using the film.

Based upon the above, even if the negative electrode 22 includes the lithium metal having high reactivity, the decomposition reaction of the electrolytic solution on the surface of the negative electrode 22 is suppressed upon charging and discharging.

In this case, in particular, because the content of the orthocarbonic acid ester compound in the solvent is made appropriate, the orthocarbonic acid ester compound sufficiently exerts a protective function of protecting the surface of the negative electrode 22. Thus, the surface of the negative electrode 22 is sufficiently and stably protected by using the film derived from the electrolyte salt and the other solvent, which sufficiently and stably suppresses the decomposition reaction of the electrolytic solution.

In particular, the content of the orthocarbonic acid ester compound in the solvent is preferably greater than or equal to 60 wt %, and more preferably greater than or equal to 80 wt %. One reason for this is that this allows the orthocarbonic acid ester compound to further exert the protective function, which further suppresses the decomposition reaction of the electrolytic solution.

Further, the orthocarbonic acid ester compound preferably includes tetramethyl orthocarbonate. One reason for this is that this allows the orthocarbonic acid ester compound to sufficiently exert the protective function, which sufficiently suppresses the decomposition reaction of the electrolytic solution.

To confirm that the solvent includes the orthocarbonic acid ester compound and to measure the content of the orthocarbonic acid ester compound in the solvent, the electrolytic solution is analyzed. A method of analyzing the electrolytic solution is not particularly limited, and specifically includes any one or more of methods including, without limitation, inductively coupled plasma (ICP) optical emission spectroscopy, nuclear magnetic resonance (NMR) spectroscopy, and gas chromatography mass spectrometry (GC-MS).

When analyzing the electrolytic solution, the secondary battery is disassembled to thereby take out the electrolytic solution, following which the electrolytic solution is analyzed. Thus, a kind of a component included in the electrolytic solution is identified as the orthocarbonic acid ester compound, and a content of the component is also identified.

Note that the solvent may further include any one or more of other compounds. As is apparent from the above-described range of the content of the orthocarbonic acid ester compound in the solvent, the solvent may include the other compound together with the orthocarbonic acid ester compound.

The other compound is a non-aqueous solvent (an organic solvent). Note that the above-described orthocarbonic acid ester compound is excluded from the other compound described here.

The non-aqueous solvent is, for example, an ester or an ether, more specifically, a carbonic-acid-ester-based compound, a carboxylic-acid-ester-based compound, or a lactone-based compound, for example. One reason for this is that a dissociation property of the electrolyte salt improves and ion mobility also improves.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

Examples of the non-aqueous solvent further include an unsaturated cyclic carbonic acid ester, a fluorinated cyclic carbonic acid ester, a sulfonic acid ester, a phosphoric acid ester, an acid anhydride, a nitrile compound, and an isocyanate compound. Use of these compounds makes it possible to improve electrochemical stability of the electrolytic solution.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). This content allows high ion conductivity to be obtained.

A content of the electrolyte salt is not particularly limited, and is specifically within a range from 0.3 mol/kg to 5.0 mol/kg both inclusive with respect to the solvent. One reason for this is that high ion conductivity is obtainable.

The secondary battery operates as described below in the battery device 20.

Upon charging the secondary battery, lithium is extracted from the positive electrode 21 in the ionic state. Thus, lithium moves to the negative electrode 22 via the electrolytic solution, which causes the lithium metal to be precipitated on the surface of the negative electrode 22.

Upon discharging the secondary battery, the lithium metal is eluted from the negative electrode 22. Thus, lithium moves to the positive electrode 21 via the electrolytic solution in the ionic state, which causes lithium to be inserted into the positive electrode 21.

When manufacturing the secondary battery, the positive electrode 21 and the negative electrode 22 are each fabricated and the electrolytic solution is prepared, following which the secondary battery is assembled and the assembled secondary battery is subjected to a stabilization process, in accordance with an example procedure described below.

First, the positive electrode active material, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent. Lastly, the positive electrode mixture slurry is applied on the two opposed surfaces of the positive electrode current collector 21A to thereby form the positive electrode active material layers 21B. Thereafter, the positive electrode active material layers 21B may be compression-molded using a compression apparatus such as a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 including the lithium metal as a negative electrode active material is prepared. In this case, a lithium metal foil, for example, may be attached to a negative electrode current collector to thereby fabricate the negative electrode 22.

The electrolyte salt is put into the solvent including the orthocarbonic acid ester compound, following which the solvent is stirred. In this case, an amount of the orthocarbonic acid ester compound to be put in is so adjusted that the content of the orthocarbonic acid ester compound in the solvent falls within the above-described range. The electrolyte salt is thereby dissolved in the solvent. The electrolytic solution is thus prepared.

First, the positive electrode lead 31 is coupled to the positive electrode current collector 21A of the positive electrode 21 by a joining method such as a welding method. The negative electrode lead 32 is coupled to the negative electrode 22 by the joining method such as the welding method.

Thereafter, the positive electrode 21 and the negative electrode 22 are stacked on each other with the separator 23 interposed therebetween to thereby form a stacked body (not illustrated). Thereafter, the stacked body is wound to thereby fabricate a wound body (not illustrated), following which the wound body is pressed using a compression apparatus such as a pressing machine to thereby shape the wound body into an elongated shape. The shaped wound body has a configuration similar to that of the battery device 20 except that the positive electrode 21 and the separator 23 are each not impregnated with the electrolytic solution.

Thereafter, the wound body is placed in the depression part 10U, following which the outer package film 10 (the fusion-bonding layer/the metal layer/the surface protective layer) is folded to thereby cause parts of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained in the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the wound body is sealed in the outer package film 10 having the pouch shape. The secondary battery is thus assembled.

The assembled secondary battery is charged and discharged. Stabilization conditions including, for example, an environment temperature, the number of times of charging and discharging (the number of cycles), and charging and discharging conditions may be set as desired.

As a result, a film is formed on each of a surface of the positive electrode 21 and the surface of the negative electrode 22. In this case, the film derived from the electrolyte salt and the other compound is formed on the surface of the negative electrode 22, as described above.

The battery device 20 is thus brought into an electrochemically stabilized state, and the secondary battery is completed.

According to the secondary battery, the negative electrode 22 includes the lithium metal. The solvent of the electrolytic solution includes the orthocarbonic acid ester compound. The content of the orthocarbonic acid ester compound in the solvent is greater than or equal to 40 wt %.

In this case, as described above, the property of the orthocarbonic acid ester compound is used to improve the solubility of the electrolyte salt in the solvent and to make it easier for a favorable film derived from the electrolyte salt and the other compound to be formed on the surface of the negative electrode 22 upon charging and discharging. The surface of the negative electrode 22 is thus electrochemically protected by using the film. As a result, even if the negative electrode 22 includes the lithium metal having high reactivity, the decomposition reaction of the electrolytic solution on the surface of the negative electrode 22 is suppressed upon charging and discharging. Accordingly, it is possible to achieve a superior battery characteristic.

In particular, the content of the orthocarbonic acid ester compound in the solvent may be greater than or equal to 60 wt %. This further suppresses the decomposition reaction of the electrolytic solution by using the protective function of the orthocarbonic acid ester compound. Accordingly, it is possible to achieve higher effects. In this case, the content of the orthocarbonic acid ester compound in the solvent may be greater than or equal to 80 wt %. This even further suppresses the decomposition reaction of the electrolytic solution. Accordingly, it is possible to achieve even higher effects.

Further, in Formula (1) related to the orthocarbonic acid ester compound, the hydrocarbon group may include an alkyl group, and the carbon number of the alkyl group may be less than or equal to 3. This improves the solubility and the compatibility of the orthocarbonic acid ester compound. Accordingly, it is possible to achieve higher effects.

Further, the orthocarbonic acid ester compound may include tetramethyl orthocarbonate, which allows the orthocarbonic acid ester compound to sufficiently exert the protective function. This sufficiently suppresses the decomposition reaction of the electrolytic solution. Accordingly, it is possible to achieve higher effects.

The configuration of the secondary battery is appropriately modifiable as described below according to an embodiment. Note that any of the following series of modification examples may be combined with each other.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress misalignment of the battery device 20. This suppresses winding displacement of each of the positive electrode 21, the negative electrode 22, and the separator 23, and thus suppresses swelling of the secondary battery even if the decomposition reaction of the electrolytic solution occurs. The polymer compound layer includes, for example, polyvinylidene difluoride. One reason for this is that polyvinylidene difluoride is superior in physical strength and is electrochemically stable.

Note that the porous film, the polymer compound layer, or both may each include any one or more kinds of insulating particles. One reason for this is that the insulating particles dissipate heat upon heat generation by the secondary battery, thus improving safety or heat resistance of the secondary battery. The insulating particles include any one or more of insulating materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

When fabricating the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in the ionic state between the positive electrode 21 and the negative electrode 22, and similar effects are therefore achievable. In this case, in particular, the swelling of the secondary battery is further suppressed, as described above. Accordingly, it is possible to achieve higher effects.

The electrolytic solution that is a liquid electrolyte is used. However, although not specifically illustrated here, an electrolyte layer, which is a gel electrolyte, may be used.

In the battery device 20 including the electrolyte layer, the positive electrode 21 and the negative electrode 22 are wound, being opposed to each other with the separator 23 and the electrolyte layer interposed therebetween. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. When forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, a lithium ion is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

FIG. 3 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58 as a thermosensitive resistive device, and a temperature detector 59. However, the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging current and a discharging current are each detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 4 and Comparative Examples 1 and 2

Secondary batteries were manufactured, following which the secondary batteries were each evaluated for a battery characteristic as described below.

### Fabrication of Secondary Battery

Here, a test secondary battery was fabricated to conduct a simple evaluation for the battery characteristic, in accordance with the following procedure. The test secondary battery was a simple lithium metal secondary battery.

First, the electrolyte salt (lithium bis(trifluoromethanesulfonyl)imide) was put into the solvent, following which the solvent was stirred to thereby prepare the electrolytic solution.

Used as the solvent was tetramethyl orthocarbonate (OTTM) as the orthocarbonic acid ester compound and 1,2-dimethoxyethane (DME) as the other compound. In this case, a mixture ratio between the orthocarbonic acid ester compound and the other compound was adjusted. The content of the electrolyte salt was set to 1 mol/l (=1 mol/dm³) with respect to the solvent.

The content (wt %) of the orthocarbonic acid ester compound in the solvent and the content (wt %) of the other compound in the solvent were as listed in Table 1.

Thereafter, a lithium metal foil (having a thickness of 0.1 mm) was pressure-bonded to a copper foil (having a thickness of 0.01 mm) using a pressing machine to thereby fabricate a test electrode.

Thereafter, the electrolytic solution was dropped onto the separator (a microporous polyethylene film having a thickness of 10 μm) to thereby impregnate the separator with the electrolytic solution. An amount of the dropped electrolytic solution was 0.01 ml (=0.01 cm³).

Thereafter, a copper foil (having a thickness of 0.012 mm) was prepared as a counter electrode, following which the test electrode and the counter electrode were stacked on each other with the separator impregnated with the electrolytic solution interposed therebetween. The test electrode and the counter electrode were thereby opposed to each other with the separator impregnated with the electrolytic solution interposed therebetween. The test secondary battery was thus completed.

### Evaluation of Battery Characteristic

The secondary batteries were each evaluated for a charge and discharge characteristic as the battery characteristic in accordance with the following procedure, and the evaluation revealed the results presented in Table 1.

When evaluating the charge and discharge characteristic, the secondary battery was first charged in an ambient temperature environment (at a temperature of 23° C.) to thereby measure a charge capacity, following which the secondary battery was discharged to thereby measure a discharge capacity.

Upon the charging, the secondary battery was charged with a current density of 0.22 mA/cm² until a total charging time reached three hours. Upon the discharging, the secondary battery was discharged until a voltage reached 0.1 V.

Thus, a coulombic efficiency was calculated based on the following calculation expression: coulombic efficiency (%)=(discharge capacity/charge capacity)×100.

Thereafter, the secondary battery was repeatedly charged and discharged in the same environment until the total number of cycles reached 25 cycles, while the coulombic efficiency was calculated every cycle. The charging and discharging conditions were as described above.

Lastly, an average value of 16 coulombic efficiencies calculated in the respective 10th to 25th cycles was calculated to thereby calculate an average coulombic efficiency as an index for evaluating the charge and discharge characteristic. Note that a value of the average coulombic efficiency was a value rounded off to one decimal place.

Nine coulombic efficiencies calculated in earlier cycles of charging and discharging (the first to ninth cycles) were not used to calculate the average coulombic efficiency. One reason for this was that the coulombic efficiency tended to vary in the earlier cycles of charging and discharging. To calculate the average coulombic efficiency, only the coulombic efficiencies calculated in later cycles of charging and discharging (the 10th to 25th cycles) were used, without using the coulombic efficiencies calculated in the earlier cycles of charging and discharging, to thereby prevent the coulombic efficiency from varying. Calculation accuracy and reproducibility of the average coulombic efficiency were thus secured.

TABLE 1

| | Solvent | | | | |
|---|---|---|---|---|---|
| | Orthocarbonic acid | | Other | | Average |
| | ester compound | | compound | | coulombic |
| | | Content | | Content | efficiency |
| | Kind | (wt %) | Kind | (wt %) | (%) |
| Comparative | — | — | DME | 100 | 74.5 |
| example 1 | | | | | |
| Comparative | OTTM | 20 | DME | 80 | 74.4 |
| example 2 | | | | | |
| Example 1 | OTTM | 40 | DME | 60 | 83.0 |
| Example 2 | OTTM | 60 | DME | 40 | 92.1 |
| Example 3 | OTTM | 80 | DME | 20 | 95.7 |
| Example 4 | OTTM | 100 | — | — | 95.7 |

As indicated in Table 1, the average coulombic efficiency varied depending on the composition of the solvent.

Specifically, when the content of the orthocarbonic acid ester compound in the solvent was less than 40 wt % (Comparative examples 1 and 2), the average coulombic efficiency decreased.

In contrast, when the content of the orthocarbonic acid ester compound in the solvent was greater than or equal to 40 wt % (Examples 1 to 4), the average coulombic efficiency increased. In this case, in particular, when the content of the orthocarbonic acid ester compound in the solvent was greater than or equal to 60 wt % (Examples 2 to 4), the average coulombic efficiency further increased. Further, when the content of the orthocarbonic acid ester compound in the solvent was greater than or equal to 80 wt % (Examples 3 and 4), the average coulombic efficiency even further increased.

Note that in Japanese Unexamined Patent Application Publication No. 2002-270222, an orthocarbonic acid ester similar to the orthocarbonic acid ester compound is included.

However, a secondary battery disclosed in Japanese Unexamined Patent Application Publication No. 2002-270222 is a lithium-ion secondary battery, not a lithium metal secondary battery. In addition, in the secondary battery disclosed in Japanese Unexamined Patent Application Publication No. 2002-270222, a compound of the orthocarbonic acid ester included in a non-aqueous electrolytic solution is within a range from 0.001 mmol/g to 0.18 mmol/g both inclusive, and a content of the orthocarbonic acid ester in the non-aqueous electrolytic solution is therefore expected to be less than 40 wt % when converted into the content of the orthocarbonic acid ester compound in the solvent.

Accordingly, Japanese Unexamined Patent Application Publication No. 2002-270222 does not disclose an appropriate range of the content of the orthocarbonic acid ester, which is necessary to increase the average coulombic efficiency, in the lithium metal secondary battery.

Based upon the results presented in Table 1, when: the test electrode included the lithium metal; the solvent of the electrolytic solution included the orthocarbonic acid ester compound; and the content of the orthocarbonic acid ester compound in the solvent was greater than or equal to 40 wt %, a high average coulombic efficiency was obtained. The charge and discharge characteristic was thus improved. Accordingly, it was possible to achieve a superior battery characteristic and superior safety.

Although the present technology has been described herein including with reference to embodiments and Examples, the configuration of the present technology is not limited to those described with reference to the embodiments and Examples above, and is therefore modifiable in a variety of ways.

For example, the description has been given of the case where the secondary battery has a battery structure of the laminated-film type. However, the battery structure of the secondary battery is not particularly limited, and may be, for example, of a cylindrical type, a prismatic type, a coin type, or a button type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

The effects described herein are mere examples, and effects of the present technology are therefore not limited to those described herein. Accordingly, the present technology may achieve any other effect.

Note that the present technology may have any of the following configurations according to an embodiment.
<1>
   A secondary battery including:
   a positive electrode;
   a negative electrode including lithium metal; and
   an electrolytic solution including a solvent, in which
   the solvent includes an orthocarbonic acid ester compound represented by Formula (1), and
   a content of the orthocarbonic acid ester compound in the solvent is greater than or equal to 40 weight percent,

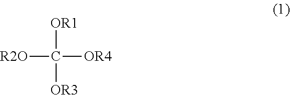

where
each of R1, R2, R3, and R4 is a hydrocarbon group.
<2>
   The secondary battery according to <1>, in which
   the content of the orthocarbonic acid ester compound in the solvent is greater than or equal to 60 weight percent.
<3>
   The secondary battery according to <2>, in which
   the content of the orthocarbonic acid ester compound in the solvent is greater than or equal to 80 weight percent.
<4>
   The secondary battery according to any one of <1>to <3>, in which
   the hydrocarbon group includes an alkyl group, and
   carbon number of the alkyl group is less than or equal to 3.
<5>
   The secondary battery according to any one of <1>to <4>, in which
   the orthocarbonic acid ester compound includes tetramethyl orthocarbonate.

### REFERENCE SIGNS LIST

21 . . . positive electrode
22 . . . negative electrode

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including lithium metal; and
an electrolytic solution including a solvent, wherein
the solvent includes an orthocarbonic acid ester compound represented by Formula (1), and
a content of the orthocarbonic acid ester compound in the solvent is greater than or equal to 40 weight percent, 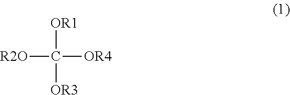
where
each of R1, R2, R3, and R4 is a hydrocarbon group.

2. The secondary battery according to claim 1, wherein
the content of the orthocarbonic acid ester compound in the solvent is greater than or equal to 60 weight percent.

3. The secondary battery according to claim 2, wherein
the content of the orthocarbonic acid ester compound in the solvent is greater than or equal to 80 weight percent.

4. The secondary battery according to claim 1, wherein
the hydrocarbon group includes an alkyl group, and
carbon number of the alkyl group is less than or equal to 3.

5. The secondary battery according to claim 1, wherein
the orthocarbonic acid ester compound includes tetramethyl orthocarbonate.
